(19) United States
(12) Patent Application Publication
(10) Pub. No.: US 2026/0005431 A1
(43) Pub. Date: Jan. 1, 2026

(54) ANTENNA SYSTEM AND ELECTRONIC DEVICE

(71) Applicant: HUAWEI TECHNOLOGIES CO., LTD., Shenzhen (CN)

(72) Inventors: Lijun Ying, Shanghai (CN); Dong Yu, Shanghai (CN); Yiwen Gong, Shanghai (CN); Hanyang Wang, Reading (GB)

(21) Appl. No.: 18/880,785

(22) PCT Filed: Aug. 7, 2023
(86) PCT No.: PCT/CN2023/111416

§ 371 Date: Jan. 2, 2025

(30) Foreign Application Priority Data
Aug. 23, 2022 (CN) 202211014485.0
Jan. 20, 2023 (CN) 202310143745.2

(51) Int. Cl. H01Q 1/52; H01Q 1/22; H01Q 5/314; H01Q 9/04

(52) U.S. Cl. CPC H01Q 1/52; H01Q 1/22; H01Q 5/314; H01Q 9/0421; H01Q 9/0457

(57) ABSTRACT

An antenna system is provided, including a first antenna and a ground. The first antenna includes a first feed circuit, an electrical component, a first stub, and a second stub. The second stub is coupled to the first stub at a first connection point, and the first stub is coupled to the ground, to form a ground stub of the first antenna. The second stub includes a first sub stub and a second sub stub, and the first sub stub and the second sub stub are located on two sides of the first connection point. The first sub stub is coupled to the first feed circuit, and is configured to perform feeding on the first antenna. In addition, a length of the second sub stub is different from a length of the first sub stub, and the second sub stub is coupled to the ground through the electrical component.

### CROSS-REFERENCE TO RELATED APPLICATIONS

This application is a National Stage of International Application No. PCT/CN2023/111416, filed on Aug. 7, 2023, which claims priority to Chinese Patent Application No. 202310143745.2, filed on Jan. 20, 2023 and Chinese Patent Application No. 202211014485.0, filed on Aug. 23, 2022, all of which are hereby incorporated by reference in their entireties.

### TECHNICAL FIELD

This application relates to the field of communication technologies, and in particular, to an antenna system and an electronic device.

### BACKGROUND

People's increasing requirements for a data transmission rate facilitate development of a multi-input multi-output (Multi-Input Multi-output, MIMO) antenna technology. A multi-input multi-output antenna can improve spectral efficiency of signal transmission, increase a channel capacity and a signal transmission rate, and further improve signal receiving reliability of a wireless communication system. Therefore, the multi-input multi-output antenna is one of key technologies of wireless communication devices.

However, when several adjacent antennas operating on adjacent frequency bands are disposed in limited space of a terminal device, coupling between antennas with an excessively short distance is strong, and therefore isolation between intra-frequency antennas and isolation between antennas operating on adjacent operating frequency bands are poor. This leads to problems such as mutual coupling interference, low antenna efficiency, and a sharp change in a radiation pattern. Therefore, it is urgent to implement a compact high-isolation antenna design solution.

### SUMMARY

This application provides an antenna system and an electronic device, to improve efficiency of the antenna system.

According to a first aspect, this application provides an antenna system. The antenna system includes a first antenna and a ground. The first antenna includes a first feed circuit, an electrical component, a first stub, and a second stub. The second stub is coupled to the first stub at a first connection point, and the first stub is coupled to the ground, to form a ground stub of the first antenna. The second stub includes a first sub stub and a second sub stub, and the first sub stub and the second sub stub are located on two sides of the first connection point. The first sub stub is coupled to the first feed circuit, and is configured to perform feeding on the first antenna. In addition, a length of the second sub stub is different from a length of the first sub stub, and the second sub stub is coupled to the ground through the electrical component. The electrical component is disposed, so that an equivalent electrical length of the second sub stub is close to or slightly greater than an equivalent electrical length of the first sub stub. This can improve antenna efficiency of the first antenna, and achieve a simple structure and small occupied space.

Specifically, when the second stub is disposed, the first sub stub and the second sub stub extend on a same straight line.

In a technical solution, the length of the second sub stub is less than the length of the first sub stub. In this case, the electrical component is a capacitor, and an equivalent capacitance value of the capacitor is within a range of 0.2 pf to 6 pf. A capacitance value within this range can meet a requirement of improving antenna efficiency.

Specifically, when the electrical component includes one or more capacitors, a capacitance value of each capacitor may be within the range of 0.2 pf to 6 pf.

In addition, the electrical component includes an adjustable capacitor. The adjustable capacitor may mean switching capacitors with fixed capacitance values through a switch, or may mean forming series and/or parallel capacitors by turning on one or more switch branches, or may be an adjustable capacitor with a steplessly-adjustable capacitance value.

When the length of the second sub stub is less than the length of the first sub stub, the length of the second sub stub is 30% to 95% of the length of the first sub stub. Within this range, the equivalent electrical length of the second sub stub may be adjusted by disposing the foregoing electrical component, to improve antenna efficiency.

When the first antenna operates, the first antenna generates a first resonance and a second resonance, where a center frequency of the first resonance is higher than a center frequency of the second resonance, the first resonance is used to cover an operating frequency band of the first antenna, and the second resonance is used to improve system efficiency of the first resonance, that is, to improve system efficiency on the operating frequency band of the first antenna.

A frequency difference between the center frequency of the first resonance and the center frequency of the second resonance is less than or equal to 15% of a lower center frequency. Specifically, the frequency difference between the center frequency of the first resonance and the center frequency of the second resonance is less than or equal to 100 MHz, for example, may be 50 MHz. A smaller frequency difference between the center frequency of the first resonance and the center frequency of the second resonance indicates better system efficiency on the operating frequency band of the first antenna.

Specifically, when the first resonance and the second resonance are formed, the first sub stub, the second sub stub, and the electrical component are configured to generate the first resonance, and currents corresponding to the first resonance are codirectional currents on the first sub stub and the second sub stub.

The second sub stub and the electrical component are configured to generate the second resonance, and a current corresponding to the second resonance is a codirectional current on the second sub stub.

Specifically, when the second stub is disposed, the second stub includes a first open end and a second open end, where the first open end is located at an end that is of the first sub stub and that is away from the second sub stub, and the second open end is located at an end that is of the second sub stub and that is away from the first sub stub.

A distance between the second open end and a position at which the electrical component is coupled to the second sub stub is within 40% of a total length of the second sub stub. A shorter distance between the second open end and the position at which the electrical component is coupled to the second sub stub is more conducive to full utilization of a physical length of the second sub stub. Specifically, the distance between the second open end and the position at which the capacitor is coupled to the second sub stub may be within 10 mm, for example, is 5 mm or shorter. Specifically, the distance may be set with reference to a preparation process and a structure layout.

In another technical solution, the antenna system further includes a second antenna, and the second antenna includes a second feed circuit, a third stub, and a fourth stub. A first end of the fourth stub is coupled to the third stub, the third stub is coupled to the ground, the fourth stub is coupled to the second feed circuit, a second end of the fourth stub is disposed opposite to the second sub stub, and a slot exists between the second end of the fourth stub and the second sub stub. The first antenna and the second antenna may share the foregoing slot, that is, each of the fourth stub and the second sub stub forms an open end through the slot. Therefore, the first antenna and the second antenna are disposed compactly, and occupy small space. In this solution, the second sub stub is connected to the electrical component, and the equivalent electrical length of the second sub stub may be slightly greater than or close to an equivalent electrical length of the fourth stub and the equivalent electrical length of the first sub stub by loading the electrical component. In this way, electrical symmetry can be achieved, operating modes of the first antenna and the second antenna can be adjusted, and isolation between the first antenna and the second antenna is improved.

When the antenna system is specifically formed, the fourth stub and the second stub are located in a same mechanical part, and the mechanical part has the foregoing slot. This solution facilitates preparation and formation of the fourth stub and the second sub stub.

The fourth stub includes a third open end, and the third open end is the second end of the fourth stub. In other words, the second end of the fourth stub is the third open end.

A width of a slot between the second end of the fourth stub and the second sub stub is 0.5 mm to 2 mm. Alternatively, a width of a slot between the third open end of the fourth stub and the second sub stub is 0.5 mm to 2 mm.

Specifically, when the stub of the antenna system is disposed, a physical length L4 of the fourth stub and a physical length L11 of the first sub stub satisfy the following: L4=L11*(100±30)%. A difference between the physical length of the fourth stub and the physical length of the first sub stub is less than 30% of the physical length of the first sub stub.

In the antenna system, the second antenna generates a third resonance and a fourth resonance, and a center frequency of the third resonance is higher than a center frequency of the fourth resonance. The third resonance is used to cover an operating frequency band of the second antenna, and the fourth resonance is used to improve isolation between the first resonance and the third resonance.

A frequency difference between the center frequency of the third resonance and the center frequency of the fourth resonance is less than or equal to 15% of a lower center frequency. Specifically, the frequency difference between the center frequency of the third resonance and the center frequency of the fourth resonance is less than or equal to 100 MHz, for example, may be 50 MHz, 40 MHz, 30 MHz or 20 MHz. A larger frequency difference between the center frequency of the third resonance and the center frequency of the fourth resonance is more conducive to improving isolation between the first antenna and the second antenna.

Specifically, when the third resonance is formed, the fourth stub, the second sub stub, and the electrical component are configured to generate the third resonance, and currents corresponding to the third resonance are reverse currents on the fourth stub and the second sub stub.

Specifically, when the fourth resonance is formed, the second sub stub and the electrical component are configured to generate the fourth resonance, and a current corresponding to the fourth resonance is a codirectional current on the second sub stub.

The operating frequency band of the first antenna includes a first frequency band, the operating frequency band of the second antenna includes a second frequency band, and a frequency difference between a center frequency of the first frequency band and a center frequency of the second frequency band is less than or equal to 15% of a lower center frequency. In a specific embodiment, the first frequency band and the second frequency band at least partially overlap, or are a same operating frequency band. In this way, the first antenna and the second antenna in the antenna system can operate cooperatively on a same operating frequency band or adjacent operating frequency bands.

According to a second aspect, this application further provides an electronic device. The electronic device includes a housing and the antenna system provided in the first aspect. A part of a structure of the housing forms a second stub and a fourth stub, to make full use of a structure of the electronic device. This helps reduce a size of an antenna. Alternatively, the antenna system may be independently prepared, and then the antenna system is disposed in the housing. The antenna system of the electronic device is high in efficiency, and isolation between different antennas is also high.

### BRIEF DESCRIPTION OF THE DRAWINGS

FIG. 1 is a diagram of a structure of an electronic device according to an embodiment of this application;

FIG. 2 is a diagram of a structure of an antenna system according to an embodiment of this application;

FIG. 3 is an S parameter curve diagram of a first antenna according to an embodiment of this application;

FIG. 4 is a diagram of a current of an antenna system according to an embodiment of this application;

FIG. 5 is a diagram of a current of an antenna system in which no electrical component is disposed;

FIG. 6 is a curve diagram of efficiency of a first antenna according to an embodiment of this application;

FIG. 7 is a diagram of another structure of an antenna system according to an embodiment of this application;

FIG. 8 is an S parameter curve diagram of a second antenna according to an embodiment of this application;

FIG. 9 is a diagram of a current of an antenna system according to an embodiment of this application;

FIG. 10 is an S parameter curve diagram of a first antenna and a second antenna according to an embodiment of this application;

FIG. 11 is an S parameter curve diagram of a first antenna and a second antenna in a case in which a second sub stub is directly coupled to a ground;

FIG. 12a is a diagram of current distribution of a first antenna according to an embodiment of this application;

FIG. 12b is a diagram of current distribution of a second antenna according to an embodiment of this application;

FIG. 13 is an operating architectural diagram of a first antenna and a second antenna according to an embodiment of this application;

FIG. 14 is a diagram of another structure of an antenna system according to an embodiment of this application;

FIG. 15 is a diagram of another structure of an antenna system according to an embodiment of this application; and

FIG. 16 is a diagram of another structure of an antenna system according to an embodiment of this application.

### REFERENCE NUMERALS

1: housing; 2: antenna system;
3: first antenna; 31: first stub;
32: second stub; 321: first sub stub;
322: second sub stub; 33: first connection point;
34: electrical component; 4: second antenna;
41: third stub; 42: fourth stub; and
5: third antenna.

### DETAILED DESCRIPTION OF ILLUSTRATIVE EMBODIMENTS

To make the objectives, technical solutions, and advantages of this application clearer, the following further describes this application in detail with reference to the accompanying drawings.

Terms used in the following embodiments are merely intended to describe specific embodiments, but are not intended to limit this application. Terms “one”, “a”, “the”, “the foregoing”, “this”, and “the one” of singular forms used in this specification and the appended claims of this application are also intended to include forms such as “one or more”, unless otherwise specified in the context clearly.

Reference to “an embodiment”, “a specific embodiment”, or the like described in this specification means that one or more embodiments of this application include a specific feature, structure, or characteristic described with reference to this embodiment. The terms “include”, “contain”, “have”, and variations thereof all mean “including but not limited to”, unless otherwise specifically emphasized in another manner.

To facilitate understanding of an antenna system and an electronic device that are provided in embodiments of this application, the following first describes an application scenario of the antenna system. An antenna provided in embodiments of this application is applicable to an electronic device that uses one or more of the following communication technologies: a Bluetooth (Bluetooth, BT) communication technology, a global positioning system (global positioning system, GPS) communication technology, a wireless fidelity (wireless fidelity, Wi-Fi) communication technology, a global system for mobile communications (global system for mobile communications, GSM) communication technology, a wideband code division multiple access (wideband code division multiple access, WCDMA) communication technology, a long term evolution (long term evolution, LTE) communication technology, a 5G communication technology, and other future communication technologies. The electronic device in embodiments of this application may be a mobile phone, a tablet computer, a notebook computer, a smart home product, a smart band, a smart watch, a smart helmet, smart glasses, an intelligent vehicle navigation apparatus, an intelligent security-protection sensing apparatus, an unmanned aerial vehicle, an unmanned transport vehicle, a robot, or a medical sensing product. Alternatively, the electronic device may be a handheld device that has a wireless communication function, a computing device, another processing device connected to a wireless modem, a vehicle-mounted device, an electronic device in a 5G network, an electronic device in a future evolved public land mobile network (public land mobile network, PLMN), or the like. This is not limited in embodiments of this application.

Any one of the foregoing electronic devices may include the antenna system in embodiments of this application, to implement a communication or detection function of the electronic device. In a specific embodiment, the antenna system in the electronic device may be directly installed in the electronic device, and is electrically connected to a processor in the electronic device, to implement a communication function and/or a detection function of the electronic device. Alternatively, the antenna system may be integrated into a sensor or a sensing module, and then the sensor or the sensing module is installed in the electronic device, and a processor of the electronic device is electrically connected to the sensor or the sensing module, to implement a communication function and/or a detection function of the electronic device. The processor may be specifically a chip provided that the processor can process data and implement at least some functions of the electronic device. This is not limited in this application.

For ease of understanding embodiments of this application, the following briefly describes terms in embodiments of this application.

Connection/Being connected to: Both the “connection” and “being connected to” may mean a mechanical connection relationship or a physical connection relationship, that is, a connection between A and B or that A is connected to B may mean that there is a fastening component (like a screw, a bolt, or a rivet) between A and B, or A and B are in contact with each other and A and B are difficult to be separated.

Coupling: The coupling may be understood as direct coupling and/or indirect coupling, and a “coupling connection” may be understood as a direct coupling connection and/or an indirect coupling connection. The direct coupling may also be referred to as an “electrical connection”, which may be understood as physical contact and electrical conductivity of components, or may be understood as a form in which different components in a line structure are connected by using a physical line that can transmit an electrical signal, like printed circuit board (printed circuit board, PCB) copper foil or a conducting wire. The “indirect coupling” may be understood as electrical conductivity of two conductors through space in a non-contact manner. In an embodiment, the indirect coupling may also be referred to as capacitive coupling. For example, signal transmission is implemented by forming an equivalent capacitor through coupling in a gap between two spaced conductive components.

Opposite or being disposed opposite to each other: That A is disposed opposite to B may mean that A and B are disposed opposite to each other or face to face (opposite to, or face to face). For example, when two radiators are disposed opposite to each other, at least some areas of the two radiators overlap in a direction. In an embodiment, two radiators disposed opposite to each other are adjacently disposed, no other radiator is disposed between the two radiators, and no conductor other than an antenna structure is disposed between the two radiators.

Lumped element: The lumped element is a general name of all elements whose sizes are far less than a wavelength corresponding to an operating frequency of a circuit. For a signal, an element characteristic is always fixed at any time, regardless of a frequency.

Distributed element: A difference between the distributed element and the lumped element lies in that if a size of an element is close to or greater than a wavelength corresponding to an operating frequency of a circuit, a characteristic of each point of the element varies with a signal when the signal passes through the element. In this case, the element cannot be considered as a single entity with a fixed characteristic, but should be referred to as a distributed element.

It should be understood that the element may also be referred to as a component, an element and component, an electrical component, or the like.

Capacitor: The capacitor may be understood as a lumped capacitor and/or a distributed capacitor. The lumped capacitor is a capacitive component, for example, a capacitive element, and the distributed capacitor (or distributed type capacitor) is an equivalent capacitor formed in manner in which two conductors are spaced by gap.

Inductor: The inductor may be understood as a lumped inductor and/or a distributed inductor. The lumped inductor is an inductive component, for example, an inductive element. The distributed inductor (or distributed type inductor) is an equivalent inductor formed by using a conductive member of a specific length.

Main radiator: The main radiator is an apparatus configured to receive/send electromagnetic wave radiation in an antenna. Specifically, the main radiator converts guided wave energy from a transmitter into a radio wave, or converts a radio wave into guided wave energy, to radiate and receive radio waves. Modulated high-frequency current energy (or guided wave energy) generated by the transmitter is transmitted to the main radiator (corresponding to a main radiator of a transmit antenna) for transmission, and the main radiator converts the modulated high-frequency current energy into electromagnetic wave energy of a specific polarization, and radiates the electromagnetic wave energy in a required direction. A main radiator (corresponding to a main radiator of a receive antenna) for receiving converts electromagnetic wave energy of a specific polarization from a specific direction of space into modulated high-frequency current energy, and transmits the modulated high-frequency current energy to an input end of a receiver.

The main radiator may be a conductor having a specific shape and size, for example, a linear radiator or a sheet-like radiator. A specific shape is not limited in this application. In an embodiment, the linear radiator may be referred to as a wire antenna for short. In an embodiment, the linear radiator may be implemented by using a conductive side frame, and may also be referred to as a side frame antenna. In an embodiment, the linear radiator may be implemented by a bracketed conductor, and may also be referred to as a bracketed antenna. In an embodiment, a diameter (for example, including a thickness and a width) of the linear radiator or a radiator of a wire antenna is much less than a wavelength (for example, a dielectric wavelength) (for example, is less than 1/16 of the wavelength), and a length may be compared with the wavelength (for example, the dielectric wavelength) (for example, the length is near ⅛ of the wavelength, or ⅛ to ¼ of the wavelength, or ¼ to ½ of the wavelength, or greater). Main forms of the wire antenna include the following: a dipole antenna, a half-wave dipole antenna, a monopole antenna, a loop antenna, an inverted F antenna (inverted F antenna, IFA), and a planar inverted F antenna (planar inverted F antenna, PIFA). For example, for the dipole antenna, each dipole antenna usually includes two radiation stubs, and each stub is fed by a feed part from a feed end of the radiation stub. For example, the inverted F antenna (Inverted F Antenna, IFA) may be considered as being obtained by adding a grounding path to the monopole antenna. The IFA antenna has a feed point and a ground point. A side view of the IFA antenna is inverted F-shaped, and therefore the IFA antenna is referred to an inverted F antenna. In an embodiment, the sheet-like radiator may include a microstrip antenna or a patch (patch) antenna. In an embodiment, the sheet-like radiator may be implemented by a planar conductor (for example, a conductive sheet or a conductive coating). In an embodiment, the sheet-like radiator may include a conductive sheet, for example, a copper sheet. In an embodiment, the sheet-like radiator may include a conductive coating, for example, silver paste. A shape of the sheet-like radiator includes a circular shape, a rectangular shape, a ring shape, and the like. A specific shape is not limited in this application. A structure of the microstrip antenna generally includes a dielectric substrate, a radiator, and a ground plane, where the dielectric substrate is disposed between the radiator and the ground plane.

The radiator may also include a slot or a silt formed on a conductor, for example, a closed or semi-closed slot or slit formed on a grounded conductor surface. In an embodiment, a radiator with a slot or slit may be referred to as a slot antenna or a slotted antenna for short. In an embodiment, a radiator with a closed slot or slit may be referred to as a closed slot antenna for short. In an embodiment, a radiator having a semi-closed slot or slit (for example, an opening is additionally provided on the closed slot or slit) may be referred to as an open slot antenna for short. In some embodiments, the slot is long strip-shaped. In some embodiments, a length of the slot is approximately half a wavelength (for example, a dielectric wavelength). In some embodiments, a length of the slot is approximately an integer multiple of a wavelength (for example, one time a dielectric wavelength). In some embodiments, the slot may be used for feeding through a transmission line bridged on one side or two sides of the slot. In this way, a radio frequency electromagnetic field is excited on the slot, and an electromagnetic wave is radiated to space. In an embodiment, a radiator of the slot antenna or the slotted antenna may be implemented by a conductive side frame that is grounded at two ends, and may also be referred to as a side frame antenna. In this embodiment, it may be considered that the slot antenna or the slotted antenna includes a linear radiator, and the linear radiator is spaced from the ground plane and is grounded at two ends of the radiator, to form a closed or semi-closed slot or slit. In an embodiment, the radiator of the slot antenna or the slotted antenna may be implemented by a bracketed conductor that is grounded at both ends, and may also be referred to as a bracketed antenna.

In this embodiment of this application, the main radiator specifically includes a stub structure. In an embodiment, the stub structure is a linear conductor.

Resonance frequency: The resonance frequency is also referred to as a resonant frequency. The resonance frequency may have a frequency range, namely, a frequency range in which a resonance occurs. The resonance frequency may be a frequency range in which a return loss is less than −6 dB. A frequency corresponding to a strongest resonance point is a center frequency, namely, a point frequency. A return loss of the center frequency may be less than −20 dB.

Resonant frequency band: A range of a resonance frequency is the resonant frequency band, and a return loss of any frequency in the resonant frequency band may be less than −6 dB or −5 dB.

Communication frequency band/Operating frequency band: Regardless of a type of antenna, the antenna always operates in a specific frequency range (frequency band width). For example, an operating frequency band of an antenna supporting a B40 frequency band includes a frequency ranging from 2300 MHz to 2400 MHz. In other words, an operating frequency band of the antenna includes a B40 frequency band. A frequency range that meets a requirement of an indicator may be considered as the operating frequency band of the antenna. A width of the operating frequency band is referred to as an operating bandwidth. An operating bandwidth of an omnidirectional antenna may be 3% to 5% of the center frequency. An operating bandwidth of a directional antenna may be 5% to 10% of the center frequency. The bandwidth may be considered as a frequency range on both sides of the center frequency (for example, a resonance frequency of a dipole antenna), where antenna characteristics are within an acceptable value range of the center frequency.

The resonant frequency band and the operating frequency band may be the same or different, or frequency ranges thereof may partially overlap. In an embodiment, the resonant frequency band of the antenna may cover a plurality of operating frequency bands of the antenna.

Ground/Ground plane: The ground/ground plane may generally refer to at least a part of any grounding plane, or grounding plate, or ground metal layer in an electronic device (like a mobile phone), or at least a part of any combination of any grounding plane, or grounding plate, or ground part. The “ground plane” may be used to ground a component in the electronic device. In an embodiment, the “ground plane” may include any one or more of the following: a grounding plane of a circuit board of the electronic device, a grounding plate formed by a middle frame of the electronic device, a ground metal layer formed by a metal film below a screen, a conductive grounding plane of a battery, and a conductive member or a metal piece electrically connected to the grounding plane/grounding plate/ground metal layer. In an embodiment, the circuit board may be a printed circuit board (printed circuit board, PCB), for example, an 8-layer board, a 10-layer board, or a 12-layer board, a 13-layer board, or a 14-layer board respectively having 8, 10, 12, 13, or 14 layers of conductive materials, or an element that is separated and electrically insulated by a dielectric layer or an insulation layer, for example, glass fiber, polymer, or the like.

Any of the foregoing grounding plane, or grounding plate, or ground metal layer is made of a conductive material. In an embodiment, the conductive material may be any one of the following materials: copper, aluminum, stainless steel, brass, an alloy thereof, copper foil on an insulation laminate, aluminum foil on an insulation laminate, gold foil on an insulation laminate, silver-plated copper, silver-plated copper foil on an insulation laminate, silver foil and tin-plated copper on an insulation laminate, cloth impregnated with graphite powder, a graphite-coated laminate, a copper-plated laminate, a brass-plated laminate, and an aluminum-plated laminate. A person skilled in the art may understand that the grounding plane/grounding plate/ground metal layer may alternatively be made of another conductive material.

Grounding: The grounding refers to coupling to the ground or ground plane in any manner. In an embodiment, the grounding may be grounding by using an entity, for example, grounding by using an entity (or referred to as entity grounding) at a specific position on the side frame is implemented by using some mechanical parts of the middle frame. In an embodiment, the grounding may be grounding by using a component, for example, grounding (or referred to as component grounding) by using a component like a capacitor/inductor/resistor connected in series or in parallel.

End/Point: An “end/point” in a first end/second end/feed end/ground end/feed point/ground point/connection point of an antenna radiator cannot be understood as a point in a narrow sense, and may be considered as a radiator section that includes a first endpoint on the antenna radiator. Alternatively, an “end/point” cannot be understood in a narrow sense as an endpoint or an end part that is disconnected from another radiator, and may be considered as a point or a section on a continuous radiator. In an embodiment, the “end/point” may include an endpoint of the antenna radiator in a first slot. For example, a first end of the antenna radiator may be considered as a radiator section within 5 mm (for example, 2 mm) away from the slot. In an embodiment, the “end/point” may include a connection/coupling area that is on the antenna radiator and that is coupled to another conductive structure. For example, the feed end/feed point may be a coupling area (for example, an area opposite to a part of the feed circuit) that is on the antenna radiator and that is coupled to the feed structure or the feed circuit. For another example, the ground end/ground point may be a connection/coupling area that is on the antenna radiator and that is coupled to the ground structure or the ground circuit.

Open end and closed end: In some embodiments, the open end and closed end are, for example, relative based on grounding, the closed end is grounded, and the open end is not grounded. In some embodiments, the open end and the closed end are, for example, relative based on another conductor, the closed end is electrically connected to the another conductor, and the open end is not electrically connected to the another conductor. In an embodiment, the open end may also be referred to as an opening end or an open-circuit end. In an embodiment, the closed end may also be referred to as a ground end or a short-circuit end.

Codirectional/Reverse current distribution mentioned in embodiments of this application should be understood as that directions of main currents on conductors on a same side are codirectional/reverse. For example, when a codirectionally distributed current (for example, a current path is bent or annular) is excited on a bent conductor or an annular conductor, it should be understood that although main currents excited on conductors on two sides in the annular conductor (for example, on conductors around a slot, or on conductors on two sides of a slot) are reverse in direction, the main currents still meet a definition of the codirectionally distributed current in this application. In an embodiment, that a current on a conductor is codirectional in direction may mean that the current on the conductor has no reverse point. In an embodiment, that a current on a conductor is reverse in direction may mean that the current on the conductor has at least one reverse point. In an embodiment, that currents on two conductors are codirectional in direction may mean that the currents on the two conductors have no reverse point and flow in a same direction. In an embodiment, that currents on two conductors are reverse in direction may mean that the currents on the two conductors have no reverse point and flow in reverse directions. It may be correspondingly understood that currents on a plurality of conductors are codirectional/reverse in direction.

A same operating frequency band (also referred to as an intra-frequency operating frequency band) mentioned in embodiments of this application may be understood as either of the following two cases.
(1) An operating frequency band of a first antenna and an operating frequency band of a second antenna include a same communication frequency band. In an embodiment, both the first antenna and the second antenna serve as subunits in a MIMO antenna system. For example, both the operating frequency band of the first antenna and the operating frequency band of the second antenna include a sub-6 GHz frequency band in 5G.
(2) An operating frequency band of a first antenna partially overlaps an operating frequency band of a second antenna. For example, the operating frequency band of the first antenna includes a frequency band B35 (1.85 GHz to 1.91 GHz) in LTE, and the operating frequency band of the second antenna includes a frequency band B39 (1.88 GHz to 1.92 GHz) in LTE.

Adjacent operating frequency bands mentioned in this application may be understood as follows.

In the operating frequency band of the first antenna and the operating frequency band of the second antenna, a spacing between a start frequency of a higher frequency band and an end frequency of a lower frequency band is less than 10% of a center frequency of the higher frequency band. For example, the operating frequency band of the first antenna includes a frequency band B3 (1.71 GHz to 1.785 GHz) in LTE, and the operating frequency band of the second antenna includes a frequency band L1 (1578.42 MHz±1.023 MHz) in GPS. If the frequency band B3 (1.71 GHz to 1.785 GHz) and the frequency band L1 (1578.42 MHz±1.023 MHz) are adjacent frequency bands, it may be considered that the operating frequency bands of the first antenna and the second antenna are adjacent. Alternatively, for example, the operating frequency band of the first antenna includes a frequency band B40 (2.3 GHz to 2.4 GHz) in LTE, and the operating frequency band of the second antenna includes a Bluetooth (also referred to as BT) frequency band (2.4 GHz to 2.485 GHz). If the frequency band B40 (2.3 GHz to 2.4 GHz) and the frequency band BT (2.4 GHz to 2.485 GHz) are adjacent frequency bands, it may be considered that the operating frequency bands of the first antenna and the second antenna are adjacent.

System efficiency: The system efficiency is a ratio of power (namely, power that is effectively converted into an electromagnetic wave) radiated by an antenna to space to input power of the antenna. The system efficiency is actual efficiency obtained by matching an antenna port, that is, the system efficiency of the antenna is the actual efficiency (namely, efficiency) of the antenna.

Radiation efficiency: The radiation efficiency is a ratio of power (namely, power that is effectively converted into an electromagnetic wave) radiated by an antenna to space to active power input to the antenna. The active power input to the antenna=input power of the antenna−loss power. The loss power mainly includes return loss power and metal ohmic loss power and/or medium loss power. A metal loss and a dielectric loss are factors affecting radiation efficiency.

A person skilled in the art may understand that the efficiency is usually indicated by a percentage, and there is a corresponding conversion relationship between the efficiency and dB. Efficiency closer to 0 dB indicates better antenna efficiency.

dB: dB is a decibel, and is a logarithmic concept with ten as the base. Decibel is only used to evaluate a proportional relationship between a physical quantity and another physical quantity, and has no physical dimension. A difference between the two quantities can be expressed as 10 decibels for each 10 times increase in the ratio. For example, if A=“100”, B=“10”, C=“5”, and D=“1”, A/D=20 dB, B/D=10 dB, C/D=7 dB, and B/C=3 dB. In other words, the difference of 10 decibels between two quantities indicates that the difference is 10 times, the difference of 20 decibels between two quantities indicates that the difference is 100 times, and the rest may be deduced by analogy. A difference of 3 dB indicates that the difference between two quantities is twice.

dBi: dBi is generally mentioned together with dBd. Herein, dBi and dBd are units of a power gain, and are relative values with different references. The reference for dBi is an omnidirectional antenna, and the reference for dBd is a dipole antenna. Generally, dBi and dBd indicate a same gain. A value indicated by dBi is greater than that indicated by dBd by 2.15 dBi. For example, for an antenna with a gain of 16 dBd, the gain is 18.15 dBi when measured in dBi, and is generally 18 dBi when decimal places are ignored.

Antenna return loss: The antenna return loss may be understood as a ratio of power of a signal reflected back to an antenna port through an antenna circuit to transmit power of the antenna port. A smaller reflected signal indicates a larger signal radiated by the antenna to space and higher radiation efficiency of the antenna. A larger reflected signal indicates a smaller signal radiated by the antenna to space and lower radiation efficiency of the antenna.

The antenna return loss may be represented by an S11 parameter, and S11 is one of S parameters. S11 indicates a reflection coefficient, and the parameter indicates transmit efficiency of the antenna.

In an embodiment, an S11 diagram may be understood as a diagram of a resonance generated by an antenna. In an embodiment, a resonance shown in the S11 diagram in a part in which a value of S11 less than −6 dB may be understood as a resonance frequency/a frequency range/an operating frequency band generated by the antenna. The S11 parameter is usually a negative number. A smaller value of the S11 parameter indicates a smaller return loss of the antenna and less energy reflected back by the antenna. In other words, more energy actually entering the antenna indicates higher system efficiency of the antenna. A larger S11 parameter indicates a larger return loss of the antenna and lower system efficiency of the antenna.

It should be noted that, −6 dB is usually used as a standard value of S11 in engineering. When the value of S11 of the antenna is less than −6 dB, it may be considered that the antenna can operate normally, or it may be considered that transmit efficiency of the antenna is good.

Isolation: The isolation refers to a ratio of power of a signal transmitted by an antenna to power of a signal received by another antenna. The isolation is a physical quantity used to measure a degree of mutual coupling between antennas. If two antennas form a dual-port network, isolation between the two antennas is S21 and S12 for the antennas. The isolation between antennas may be represented by parameters S21 and S12, and is also one of the S parameters. The parameters S21 and S12 are usually negative numbers. Smaller S21 and S12 parameters indicate larger isolation between antennas and a smaller degree of mutual coupling between the antennas. Larger S21 and S12 parameters indicate smaller isolation between the antennas and a larger degree of mutual coupling between the antennas. The isolation between antennas depends on radiation patterns of the antennas, a spatial distance between the antennas, and antenna gains.

Basic mode: The basic mode corresponds to a resonance with a lowest frequency generated by a radiator section or a radiator in a specific antenna mode. A “basic-mode position” or “basic-mode resonance frequency” is a frequency range or a resonance frequency corresponding to the basic mode (for example, the resonance with the lowest frequency) of a radiator in a specific antenna mode. The “basic mode” may also be referred to as a “basic modal”. The “basic mode” corresponds to a “high order” or a “high-order mode/high-order modal”, or may be referred to as “frequency multiplication” (for example, triple frequency multiplication or quintuple frequency multiplication). Unless otherwise specified, the “resonance” in embodiments of this application is a resonance in the basic mode, or a resonance generated in the basic modal.

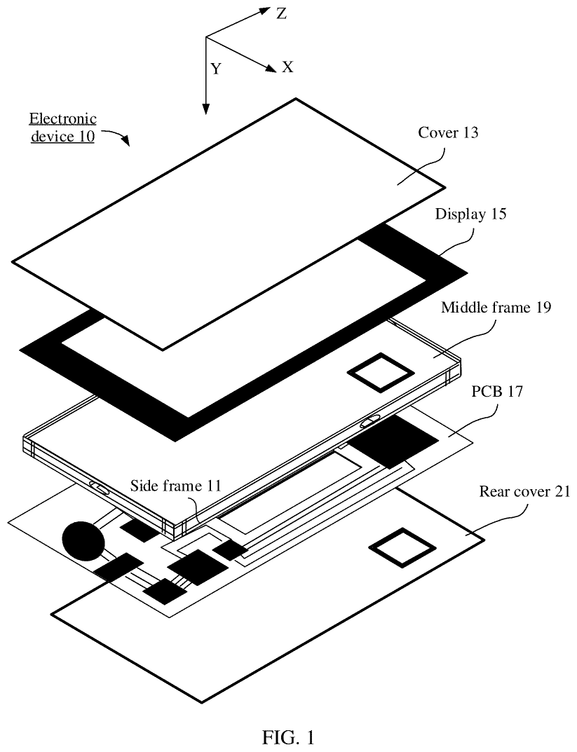

FIG. 1 is a diagram of a structure of an electronic device according to an embodiment of this application. As shown in FIG. 1, an example in which an electronic device 10 is a mobile phone is used.

As shown in FIG. 1, the electronic device 10 may include a cover (cover) 13, a display/module (display) 15, a printed circuit board (printed circuit board, PCB) 17, a middle frame (middle frame) 19, and a rear cover (rear cover) 21. It should be understood that, in some embodiments, the cover 13 may be a cover glass (cover glass), or may be replaced with a cover of another material, for example, an ultra-thin glass material cover or a polyethylene terephthalate (Polyethylene terephthalate, PET) material cover.

The cover 13 may be tightly attached to the display 15, and may be mainly used to protect the display 15 for dust resistance.

In an embodiment, the display 15 includes a liquid crystal display (liquid crystal display, LCD) panel, a light-emitting diode (light-emitting diode, LED) display panel, an organic light-emitting diode (organic light-emitting diode, OLED) display panel, or the like. This is not limited in this application.

The middle frame 19 is mainly used to support the entire electronic device. FIG. 1 shows that the PCB 17 is disposed between the middle frame 19 and the rear cover 21. It should be understood that, in an embodiment, the PCB 17 may alternatively be disposed between the middle frame 19 and the display 15. This is not limited in this application. The printed circuit board PCB 17 may be a flame-resistant material (FR-4) dielectric board, or may be a rogers (Rogers) dielectric board, or may be a hybrid dielectric board of Rogers and FR-4, or the like. Herein, FR-4 is a grade designation for a flame-resistant material, and the Rogers dielectric board is a high-frequency board. An electronic element, for example, a radio frequency chip, is carried on the PCB 17.

In an embodiment, a metal layer may be disposed on the printed circuit board PCB 17. The metal layer may be used to ground an electronic element carried on the printed circuit board PCB 17, or may be used to ground another element, for example, a bracketed antenna or a side frame antenna. The metal layer may be referred to as a ground plane, a grounding plate, or a grounding plane. In an embodiment, the metal layer may be formed by etching metal on a surface of any dielectric board in the PCB 17. In an embodiment, the metal layer used for grounding may be disposed on a side that is of the printed circuit board PCB 17 and that is close to the middle frame 19. In an embodiment, an edge of the printed circuit board PCB 17 may be considered as an edge of a grounding plane of the printed circuit board PCB 17. In an embodiment, the metal middle frame 19 may also be configured to ground the foregoing element. The electronic device 10 may further have another ground plane/grounding plate/grounding plane. As described above. Details are not described herein again.

Due to compactness inside the electronic device, a ground plane/grounding plate/grounding plane (for example, a printed circuit board, a middle frame, a screen metal layer, a battery, and the like may all be considered as a part of the ground plane) is usually disposed in internal space 0 mm to 2 mm away from an inner surface of the side frame. In an embodiment, a medium is filled between the side frame and the ground plane, and the length and the width of a rectangle enclosed by a contour of the inner surface in which the medium is filled may be simply considered as the length and the width of the ground plane; or the length and the width of a rectangle enclosed by a contour formed by superposing all conductive parts inside the side frame may be considered as the length and the width of the ground plane.

The electronic device 10 may further include a battery (not shown in the figure). The battery may be disposed between the middle frame 19 and the rear cover 21, or may be disposed between the middle frame 19 and the display 15. This is not limited in this application. In some embodiments, the PCB 17 is divided into a mainboard and a sub-board. The battery may be disposed between the mainboard and the sub-board. The mainboard may be disposed between the middle frame 19 and an upper edge of the battery, and the sub-board may be disposed between the middle frame 19 and a lower edge of the battery.

The electronic device 10 may further include a side frame 11. The side frame 11 may be made of a conductive material such as metal. The side frame 11 may be disposed between the display 15 and the rear cover 21, and extend around a periphery of the electronic device 10. The side frame 11 may have four sides surrounding the display 15, to help fasten the display 15. In an implementation, the side frame 11 made of a metal material may be directly used as a metal side frame of the electronic device 10 to form an appearance of the metal side frame, and is applicable to a metal industrial design (industrial design, ID). In another implementation, an outer surface of the side frame 11 may alternatively be made of a non-material metal, for example, is a plastic side frame, to form an appearance of a non-metal side frame, and is applicable to a non-metal ID.

The middle frame 19 may include the side frame 11, and the middle frame 19 including the side frame 11 is used as an integral part, and may support an electronic component in the entire electronic device. The cover 13 and the rear cover 21 respectively fit upper edges and lower edges of the side frame, to enclose a casing or a housing (housing) of the electronic device. Alternatively, the side frame 11 may not be considered as a part of the middle frame 19. In an embodiment, the side frame 11 and the middle frame 19 may be connected and integrally formed. In another embodiment, the side frame 11 may include a protrusion extending inward, to be connected to the middle frame 19 by using a spring or a screw, through welding, or the like.

In an embodiment, the cover 13, the rear cover 21, the side frame 11, and/or the middle frame 19 may be collectively referred to as a casing or a housing of the electronic device 10. It should be understood that, the “casing or housing” may mean a part or all of any one of the cover 13, the rear cover 21, the side frame 11, or the middle frame 19, or mean a part or all of any combination of the cover 13, the rear cover 21, the side frame 11, or the middle frame 19.

The rear cover 21 may be a rear cover made of a metal material, or may be a rear cover made of a non-conductive material, for example, is a glass rear cover and a plastic rear cover, or may be a rear cover made of both a conductive material and a non-conductive material.

In an embodiment, the rear cover 21 including the conductive material may replace the middle frame 19, and is used as an integrated part with the side frame 11, to support an electronic component in the entire electronic device.

In an embodiment, the middle frame 19 and/or a conductive part of the rear cover 21 may be used as a reference ground of the electronic device 10. The side frame 11, the PCB 17, and the like of the electronic device may be grounded by being electrically connected to the middle frame.

In an embodiment, the side frame 11 may be at least partially used as an antenna radiator to receive/transmit a radio frequency signal as a part of the side frame of the radiator, and there may be a gap between the side frame 11 and another part of the middle frame 19 or between the side frame 11 and the middle frame 19, to ensure that the antenna radiator has a good radiation environment. In an embodiment, an aperture may be set near this part, that is used as the antenna radiator, of the side frame. In an embodiment, the aperture may include an aperture set inside the electronic device 10, for example, an aperture invisible from an appearance surface of the electronic device 10. In an embodiment, the aperture inside may be formed by any one or a plurality of a middle frame, a battery, a circuit board, a rear cover, a display, and another internal conductive member. For example, the aperture inside may be formed by a mechanical part of the middle frame. In an embodiment, the aperture may further include a slot/slit/hole provided on the side frame 11. In an embodiment, the slot/slit/hole on the side frame 11 may be a gap formed on the side frame, and the side frame 11 is divided, at the gap, into two parts that have no direct connection relationship. In an embodiment, the aperture may further include a slot/slit/hole provided on the rear cover 21 or the display 15. In an embodiment, the rear cover 21 includes a conductive material, and an aperture set at the conductive material may be connected to a slit or a gap of the side frame, to form a coherent aperture on an appearance surface of the electronic device 10.

In an embodiment, the side frame 11 includes a protruding part extending inward, configured to be connected to another part of the middle frame 19, or configured to be connected to the middle frame 19 (in an embodiment, the protruding part may also be integrally formed with the middle frame). In an embodiment, the protruding part includes a conductive material, and may be further configured to receive a feed signal or connect to the ground plane, so that a corresponding side frame part receives/transmits a radio frequency signal.

In an embodiment, the antenna of the electronic device 10 may be further disposed in the side frame 11. The side frame 11 includes a non-conductive material. The antenna radiator may be located in the electronic device 10 and disposed along the side frame 11, or the antenna radiator may be at least partially embedded into the non-conductive material of the side frame. In an embodiment, the antenna radiator is disposed adjacent to the non-conductive material of the side frame 11, to reduce a volume occupied by the antenna radiator as much as possible, and be closer to the outside of the electronic device 10, so as to achieve better signal transmission effect. It should be noted that, that the antenna radiator is disposed adjacent to the side frame 11 means that the antenna radiator may be tightly attached to the side frame 11, or may be disposed close to the side frame 11. For example, there may be a specific small slot between the antenna radiator and the side frame 11.

In an embodiment, the antenna of the electronic device 10, for example, a bracketed antenna (not shown in FIG. 1), may alternatively be disposed in the casing. A gap may exist between the antenna disposed in the casing and another conductive member in the casing, to ensure that the antenna radiator has a good radiation environment. In an embodiment, an aperture may be set near the antenna radiator. In an embodiment, the aperture may include an aperture set inside the electronic device 10, for example, an aperture invisible from an appearance surface of the electronic device 10. In an embodiment, the aperture inside may be formed by any one or a plurality of a side frame, a middle frame, a battery, a circuit board, a rear cover, a display, and another internal conductive member. For example, the aperture inside may be formed by a mechanical part of the middle frame. In an embodiment, the aperture may further include a slot/slit/hole provided on the side frame 11. In an embodiment, the slot/slit/hole on the side frame 11 may be a gap formed on the side frame, and the side frame 11 is divided, at the gap, into two parts that have no direct connection relationship. In an embodiment, the aperture may further include a slot/slit/hole provided on the rear cover 21 or the display 15. In an embodiment, the rear cover 21 includes a conductive material, and an aperture set at the conductive material may be connected to a slit or a gap of the side frame, to form a coherent aperture on an appearance surface of the electronic device 10. In an embodiment, the aperture on the rear cover 21 or the display may further be used to place another component, for example, a camera, and/or a sensor, and/or a microphone, and/or a speaker.

In an embodiment, a form of the antenna may be an antenna form based on a flexible mainboard (Flexible Printed Circuit, FPC), an antenna form based on laser-direct-structuring (Laser-Direct-structuring, LDS), or an antenna form like a microstrip disk antenna (Microstrip Disk Antenna, MDA). In an embodiment, the antenna may alternatively use a transparent or semi-transparent structure embedded into the screen of the electronic device 10, so that the antenna is a transparent antenna element embedded into the screen of the electronic device 10.

FIG. 1 shows only an example of some parts included in the electronic device 10. Actual shapes, actual sizes, and actual structures of the parts are not limited to those in FIG. 1.

It should be understood that, in embodiments of this application, it may be considered that a surface on which the display of the electronic device is located is a front surface, a surface on which the rear cover is located is a rear surface, and a surface on which the side frame is located is a side surface.

It should be understood that, in embodiments of this application, it is considered that when a user holds the electronic device (the user usually holds the electronic device vertically and faces the screen), an orientation in which the electronic device is located has a top part, a bottom part, a left part, and a right part.

In an embodiment, the electronic device 10 includes an antenna system 2, and the antenna system 2 is at least partially disposed in the housing. The antenna system 2 is configured to receive/send an electromagnetic wave, to implement a communication function of the electronic device. Efficiency of the antenna system 2 plays a decisive role in a communication capability of the electronic device.

In an embodiment, at least some radiators of the antenna system 2 may include a part of a structure of the housing. For example, the side frame of the housing of the electronic device may form a main radiator of the antenna system 2, to simplify a structure of the electronic device. Alternatively, in another embodiment, the antenna system may be disposed inside the housing.

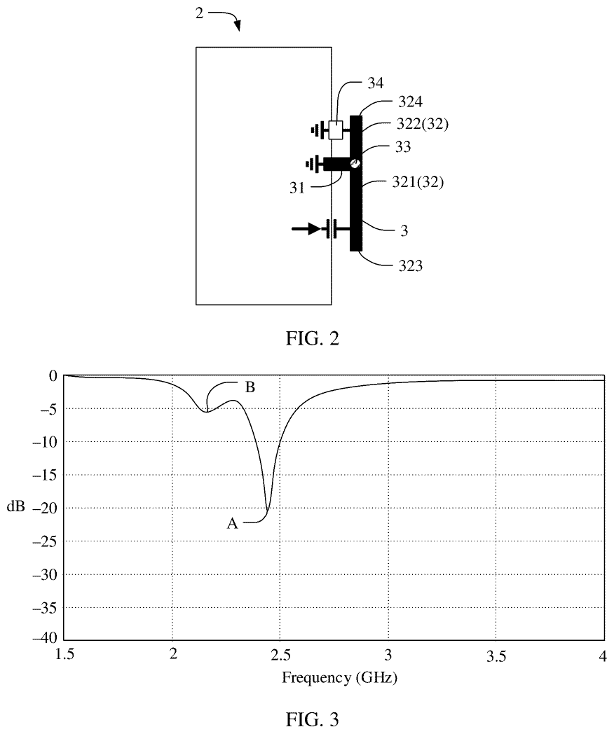

FIG. 2 is a diagram of a structure of an antenna system according to an embodiment of this application. As shown in FIG. 2, the antenna system 2 in this embodiment of this application includes a first antenna 3 and a ground. The first antenna 3 includes a first stub 31 and a second stub 32, and further includes a first feed circuit and an electrical component 34. The first stub 31 is coupled to the second stub 32 at a first connection point 33. In an embodiment, the second stub 32 includes two open ends, and the first connection point 33 is disposed between the two open ends. The second stub 32 includes a first sub stub 321 and a second sub stub 322. The first sub stub 321 and the second sub stub 322 are respectively located on two sides of the first connection point 33. It should be understood that dividing the second stub 32 into the first sub stub 321 and the second sub stub 322 by using the first connection point 33 is for ease of description of the solution, and does not merely mean that the first sub stub 321 and the second sub stub 322 are two divisible independent structures. In an embodiment, the first sub stub 321 and the second sub stub 322 may alternatively be an integrated structure. In an embodiment, the second stub 32 is divided into two parts of different lengths by using the first connection point 33. In other words, a length of the first sub stub 321 is different from a length of the second sub stub 322. In an embodiment, the length of the first sub stub 321 is greater than the length of the second sub stub 322. In an embodiment, a main radiator of the first antenna 3 is the second stub 32, and the second stub 32 is configured to receive and/or send an electromagnetic wave. In an embodiment, a main radiator of the first antenna 3 is the second stub 32 and the first stub 31, where the first stub 31 is coupled to the ground, so that the first antenna 3 is grounded through the first stub 31. In an embodiment, the first sub stub 321 is coupled to the first feed circuit, to implement feeding on the first antenna 3. In an embodiment, the second sub stub 322 is coupled to the ground through the electrical component 34. In an embodiment, the electrical component 34 may include a lumped element and/or a distributed element. The electrical component 34 may be configured to adjust an equivalent electrical length of the second sub stub 322. When the electrical component 34 is capacitive, the equivalent electrical length of the second sub stub 322 may be increased. When the electrical component 34 is inductive, the equivalent electrical length of the second sub stub 322 may be reduced. It should be understood that the inductive or capacitive electrical component 34 may include a capacitor or an inductor, or may include a capacitor and an inductor. A coupling connection position of the electrical component 34, a feeding position, and a grounding position are separately disposed through the first stub 31 and the second stub 32. In this solution, antenna efficiency of the first antenna 3 can be improved, a structure is simple, and occupied space is small.

In an embodiment, the second stub 32 may be formed on the side frame of the housing of the electronic device, where the two open ends of the second stub 32 may correspond to a gap on the side frame. In an embodiment, the gap on the side frame is an insulated gap which may be filled with a dielectric. In an embodiment, the first stub 31 may be formed on a protrusion part inside the side frame of the housing of the electronic device.

In an embodiment, the first sub stub and the second sub stub extend on a same straight line. In other words, an extension direction of the first sub stub is the same as an extension direction of the second sub stub. In this case, induced currents, on a ground plane, of currents generated by the first sub stub and the second sub stub, flow in a same direction. This helps enhance far-field radiation effect.

In a specific embodiment, when a physical length of the second sub stub 322 is less than a physical length of the first sub stub 321, the electrical component 34 is capacitive. For example, the electrical component 34 is a capacitor, and the equivalent electrical length of the second sub stub 322 may be increased through capacitive loading. In an embodiment, through the capacitive electrical component 34, the equivalent electrical length of the second sub stub 322 is slightly greater than or close to an equivalent electrical length of the first sub stub 321.

In a specific embodiment, when a physical length of the second sub stub 322 is greater than a physical length of the first sub stub 321, the electrical component 34 is inductive. For example, the electrical component 34 is an inductor, and the equivalent electrical length of the second sub stub 322 may be reduced through inductive loading. In an embodiment, through the inductive electrical component 34, the equivalent electrical length of the second sub stub 322 is slightly greater than or close to an equivalent electrical length of the first sub stub 321.

FIG. 3 is an S parameter curve diagram of the first antenna according to an embodiment of this application. Refer to FIG. 3. In an embodiment, the first antenna 3 generates a first resonance A and a second resonance B. A center frequency of the first resonance A is higher than a center frequency of the second resonance B. The first resonance is used to cover an operating frequency of the first antenna, and the second resonance is used to improve system efficiency of the first resonance, that is, to improve system efficiency on an operating frequency band of the first antenna.

In an embodiment, a frequency difference between the center frequency of the first resonance and the center frequency of the second resonance is less than or equal to 15% of a lower center frequency. The lower center frequency is a lower center frequency in the center frequency of the first resonance and the center frequency of the second resonance. In a specific embodiment, the frequency difference between the center frequency of the first resonance and the center frequency of the second resonance may be less than or equal to 350 MHz. For example, the frequency difference may be less than or equal to 250 MHz. Specifically, a smaller frequency difference between the center frequency of the first resonance and the center frequency of the second resonance indicates better system efficiency on the operating frequency band of the first antenna.

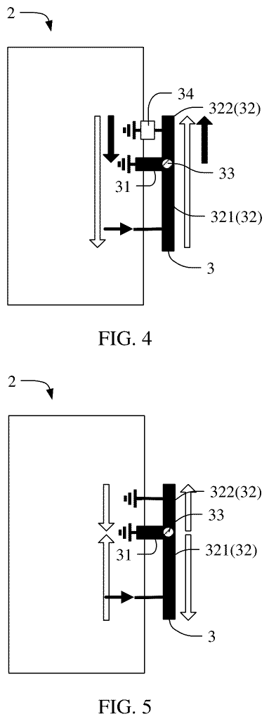

FIG. 4 is a diagram of a current of the antenna system according to an embodiment of this application. With reference to FIG. 3 and FIG. 4, in an embodiment, the first sub stub 321, the second sub stub 322, and the first capacitor 34 are configured to generate the first resonance A, and currents corresponding to the first resonance A are codirectional currents on the first sub stub 321 and the second sub stub 322. In FIG. 4, a right hollow arrow indicates a direction of currents generated by the first sub stub 321, the second sub stub 322, and the first capacitor 34, and a left hollow arrow indicates a direction of currents generated/inducted on positions at which a ground plane is adjacent to the first sub stub 321 and the second sub stub 322.

Still refer to FIG. 3 and FIG. 4. In a specific embodiment, the second sub stub 322 and the first capacitor 34 are configured to generate the second resonance B, and a current corresponding to the second resonance B is a codirectional current on the second sub stub 322. In FIG. 4, a right black arrow indicates a current generated by the second sub stub 322 and the first capacitor 34, and a left black arrow indicates a current on the ground plane and an edge of the second sub stub 322. The current corresponding to the second resonance B may enhance the current corresponding to the first resonance A, to improve system efficiency of the antenna system. In an embodiment, a frequency difference between a center frequency of the first resonance A and a center frequency of the second resonance B is less than or equal to 350 MHz, and the center frequency of the second resonance B is less than the center frequency of the first resonance A. The second resonance B may be used to improve efficiency of the first resonance A, thereby improving system efficiency of the antenna system. In addition, a current correspondingly generated on the ground plane is also a codirectional current, which may further enhance radiation efficiency of the first antenna 3 on an operating frequency band of the first antenna 3. It should be understood that, in this embodiment of this application, currents on the ground plane are in a same direction, and are superposed in a same phase in far fields. Therefore, radiation efficiency of the first antenna 3 can be improved.

When the equivalent electrical length of the second sub stub 322 is greater than the equivalent electrical length of the first sub stub 321, in terms of an S parameter, a resonance point frequency of the second resonance generated by the second sub stub 322 is lower than a resonance point frequency of the first resonance generated by the first sub stub 321. When the first resonance is adjacent to the second resonance, efficiency of the first antenna 3 on an operating frequency band of the first antenna 3 is improved. In an embodiment, a resonant frequency band of the first resonance and a resonant frequency band of the second resonance respectively at least partially overlap the operating frequency band of the first antenna 3. In an embodiment, the resonant frequency band of the first resonance is used to cover the operating frequency band of the first antenna 3, and the resonant frequency band of the second resonance is adjacent to the operating frequency band of the first antenna 3. Specifically, in terms of current distribution, the currents on the first sub stub 321 and the current on the second sub stub 322 are distributed in a same direction.

FIG. 5 is a diagram of a current of an antenna system in which the first capacitor is not disposed. As shown in FIG. 5, a length of the first sub stub 321 is greater than a length of the second sub stub 322, and the first capacitor is not disposed. A current of a resonance generated by the first sub stub 321 and a current of a resonance generated by the second sub stub 322 are reverse in direction, and currents correspondingly generated/inducted on a ground plane are also reverse in direction. The resonance generated by the first sub stub 321 may cover the operating frequency band of the first antenna 3. However, because the currents on the ground plane are reverse in direction, system efficiency of the first antenna 3 on the operating frequency band of the first antenna 3 cannot be improved. This application better resolves the problem.

Refer to FIG. 2. In an embodiment, the second stub 32 includes a first open end 323 and a second open end 324, where the first open end 323 is located at an end that is of the first sub stub 321 and that is away from the second sub stub 322, and the second open end 324 is located at an end that is of the second sub stub 322 and that is away from the first sub stub 321.

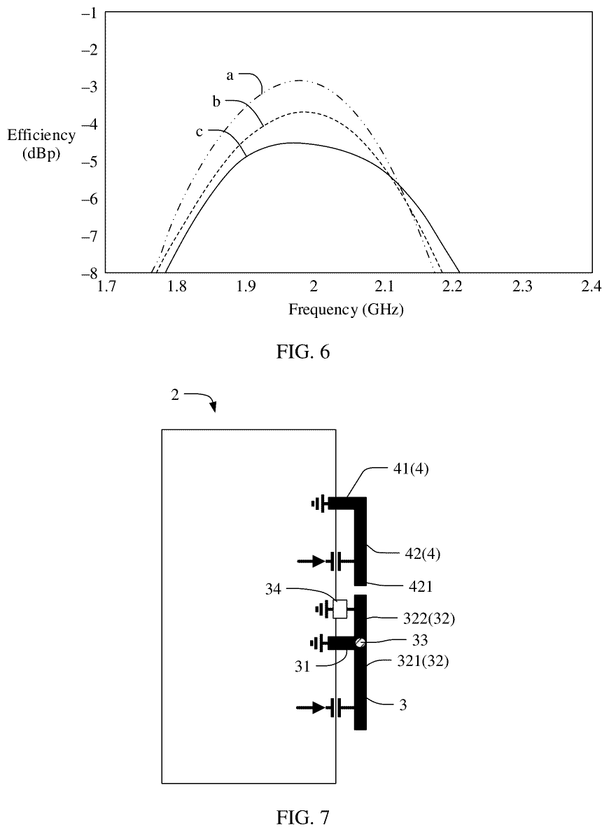

FIG. 6 is a curve diagram of efficiency of the first antenna according to an embodiment of this application. As shown in FIG. 6, the inventor analyzes this embodiment of this application and a comparative example, where the comparative example includes a first comparative example and a second comparative example. In the first comparative example, the second sub stub 322 is directly coupled to the ground. In the second comparative example, the second sub stub 322 is disconnected from the ground. In this embodiment of this application, an example in which the second sub stub 322 is coupled to the ground through a 2.5 pF capacitor is used. In an embodiment, the electrical component 34 may be, for example, a capacitor, and a capacitance value of the capacitor is 2.5 pF. In an embodiment, the electrical component 34 may be, for example, one or more capacitors and/or one or more inductors, and an equivalent capacitance value of the electrical component 34 is 2.5 pF. Still refer to FIG. 6. In the figure, a dotted line a represents an efficiency curve of the first antenna 3 in this embodiment of this application, a dashed line b represents an efficiency curve of the antenna in the first comparative example, and a solid line c represents an efficiency curve of the antenna in the second comparative example. It can be learned that when the second sub stub 322 is coupled to the ground through the electrical component 34, antenna efficiency is the highest. In this application, efficiency of the first antenna 3 can be improved.

In an embodiment, when the first capacitor is specifically disposed, a distance between the second open end 324 and a position at which the first capacitor is coupled to the second sub stub 322 is within 40% of a total length of the second sub stub 322. For example, the distance is 30% of the total length of the second sub stub 322, 20% of the total length of the second sub stub 322, 15% of the total length of the second sub stub 322, 10% of the total length of the second sub stub 322, or 5% of the total length of the second sub stub 322. This solution helps fully use a physical length of the second stub. Specifically, the distance between the second open end 324 and the position at which the first capacitor is coupled to the second sub stub 322 may be within 10 mm, for example, within 5 mm or shorter. Specifically, the distance may be set with reference to a preparation process and a structure layout.

It should be noted that, in this application, an example in which the main radiator of the first antenna 3 is a T-shaped stub is used in FIG. 2. In other words, the main radiator of the first antenna 3 includes only the first stub 31 and the second stub 32. However, in another embodiment, in addition to the first stub 31 and the second stub 32, the main radiator of the first antenna 3 may further include another stub, that is, the main radiator may be of a more complex stub structure.

In a specific embodiment, the electrical component 34 may be an adjustable component, and the adjustable component may include a component whose capacitance value or inductance value is adjustable, or may include a switch and a plurality of components, to switch between different capacitors and/or inductors. In conclusion, an equivalent electrical length of the second sub stub 322 may be adjusted by adding the adjustable component. Specifically, the equivalent electrical length of the second sub stub 322 may be adjusted according to an actual requirement, so that the first antenna 3 may have high efficiency.

In a specific embodiment, the electrical component 34 may be a lumped capacitor, for example, a fixed-capacitance capacitor or an adjustable capacitor. This is not limited in this application.

In addition, in a specific embodiment, the electrical component may be a metal mechanical part that can provide a distributed capacitor or a distributed inductor, and an implementation of the electrical device may be but is not limited to a flexible circuit board, a laser forming mechanical part, a side frame metal mechanical part, or the like.

In addition, with development of technologies, an electronic device needs to perform communication in more scenarios, and a quantity of antennas disposed in the electronic device is increasing. However, the electronic device gradually tends to be miniaturized, and space used to dispose the antennas is small. An extremely small distance between antennas easily causes poor isolation between the antennas. Therefore, this application further provides embodiments to resolve the foregoing problem.

FIG. 7 is diagram of another structure of the antenna system according to an embodiment of this application. Refer to FIG. 7. In this embodiment of this application, the antenna system 2 further includes a second antenna 4. The second antenna 4 includes a third stub 41, a fourth stub 42, and a second feed circuit. The fourth stub 42 is coupled to the third stub 41. A main radiator of the second antenna 4 includes the fourth stub 42, configured to receive and/or send an electromagnetic wave. In an embodiment, the third stub 41 is coupled to a first end of the fourth stub 42. In an embodiment, the third stub 41 is coupled to ground, so that the second antenna 4 is grounded through the third stub 41. One end that is of the third stub 41 and that is coupled to the ground is a ground end, and the other end is coupled to the first end of the fourth stub 42. A second end that is of the fourth stub 42 and that is away from the third stub 41 is an open end, and the second end is disposed opposite to the second sub stub 322. In an embodiment, the fourth stub 42 is coupled to the second feed circuit, to perform feeding on the second antenna 4. A point at which the fourth stub 42 is coupled to the second feed circuit is located between an open end and an end part at which the fourth stub 42 is coupled to the third stub 41. The second end of the fourth stub 42 is adjacent to the second sub stub 322 of the first antenna 3, and a slot exists between the second end of the fourth stub 42 and the second sub stub 322. Specifically, the first antenna 3 and the second antenna 4 may share the foregoing slot, that is, each of the fourth stub 42 and the second sub stub 322 forms an open end through the slot. Therefore, the first antenna 3 and the second antenna 4 are disposed compactly, and occupy small space. In this solution, the second sub stub 322 is connected to the electrical component 34, and an equivalent electrical length of the second sub stub 322 may be slightly greater than or close to an equivalent electrical length of the fourth stub 42 and an equivalent electrical length of the first sub stub 321 by disposing the electrical component 34. In this way, electrical symmetry can be achieved, operating modes of the first antenna 3 and the second antenna 4 can be adjusted, and isolation between the first antenna 3 and the second antenna 4 is improved.

When the second antenna 4 is specifically implemented, the third stub 41 may be a structure used for grounding, for example, may be a spring sheet or a spring plate. This is not limited in this application.

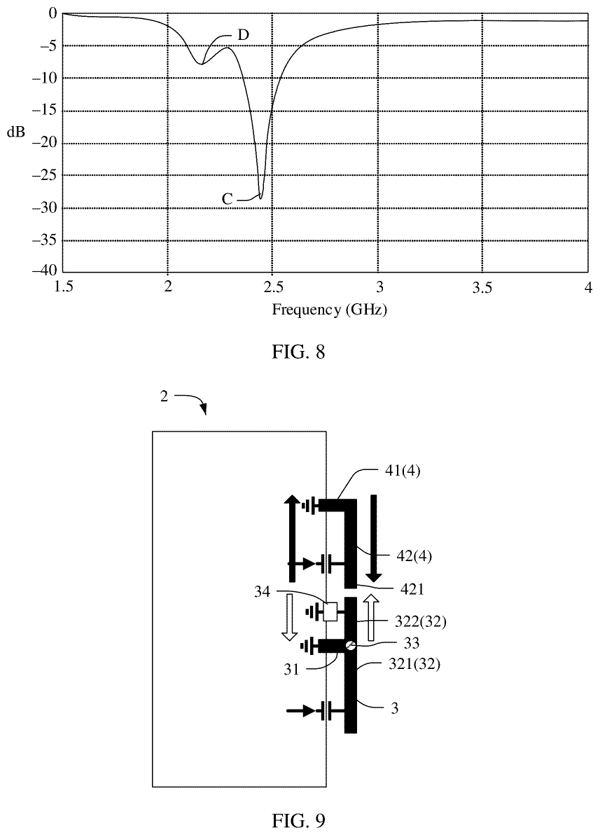

FIG. 8 is an S parameter curve diagram of the second antenna according to an embodiment of this application. Refer to FIG. 8. In an embodiment, the second antenna 4 generates a third resonance C and a fourth resonance D, a center frequency of the third resonance C is higher than a center frequency of the fourth resonance D, and the third resonance C is used to cover an operating frequency band of the second antenna 4.

In an embodiment, an operating frequency band of the first antenna 3 is the same as the operating frequency band of the second antenna 4 (for example, the first antenna 3 and the second antenna 4 are intra-frequency antennas). In an embodiment, an operating frequency band of the first antenna 3 is at least partially the same as an operating frequency band of the second antenna 4. In an embodiment, a center frequency of the operating frequency band of the first antenna 3 and a center frequency of the operating frequency band of the second antenna 4 are adjacent to each other (for example, the first antenna 3 and the second antenna 4 are adjacent-frequency antennas), for example, are less than or equal to 100 MHz.

In an embodiment, a frequency difference between the center frequency of the third resonance C and the center frequency of the second resonance D is less than or equal to 15% of a lower center frequency. The lower center frequency is a lower center frequency in the center frequency of the third resonance C and the center frequency of the fourth resonance D. In a specific embodiment, a frequency difference between the center frequency of the third resonance and the center frequency of the fourth resonance may be greater than or equal to 100 MHz. For example, the frequency difference may be greater than or equal to 200 MHz. Specifically, a larger frequency difference between the center frequency of the third resonance and the center frequency of the fourth resonance is more conducive to improving isolation between the first antenna and the second antenna.

FIG. 9 is a diagram of a current of the antenna system according to an embodiment of this application. With reference to FIG. 8 and FIG. 9, in an embodiment, when the third resonance C is specifically formed, the fourth stub 42, the second sub stub 322, and the first capacitor 34 are configured to generate the third resonance C, and currents corresponding to the third resonance Care reverse currents on the fourth stub 42 and the second sub stub 322. In the figure, a right black arrow represents a direction of a current generated on the fourth stub 42, a left black arrow represents a direction of a current at a position at which a ground plane is adjacent to the fourth stub 42, a right hollow arrow represents a direction of a current generated on the second sub stub 322, and a left hollow arrow represents a direction of a current at a position at which the ground plane is adjacent to the second sub stub 322. It can be seen that the direction of the current generated on the fourth stub 42 is reverse to the direction of the current generated on the second sub stub 322.

In addition, the second sub stub and a first electrical component are configured to generate the fourth resonance, and a current corresponding to the fourth resonance is a codirectional current on the second sub stub.

It should be understood that, when the first antenna 3 and the second antenna 4 are intra-frequency and adjacent-frequency antennas, or the operating frequency band of the first antenna 3 and the operating frequency band of the second antenna 4 partially overlap, the second sub stub 322 and the first electrical component are configured to generate the second resonance B of the first antenna 3, and are also configured to generate the fourth resonance D of the second antenna 4. When the second resonance B is close to the first resonance A, system efficiency of the first antenna 3 can be improved, and when the fourth resonance D is far away from the first resonance A, system efficiency of the second antenna 4 can be improved. In an embodiment, a length of each stub may be adjusted, and an electrical length of the second sub stub 322 may be adjusted by disposing a proper first electrical component, so that a frequency difference between a center frequency of the first resonance A and a center frequency of the second resonance B is greater than or equal to 100 MHz and less than or equal to 350 MHz, for example, is between 200 MHz and 250 MHz, and/or a frequency difference between a center frequency of the third resonance C and a center frequency of the fourth resonance D is greater than or equal to 100 MHz and less than or equal to 350 MHz, for example, is between 200 MHz and 250 MHz, to balance radiation performance of the first antenna 3 and the second antenna 4.

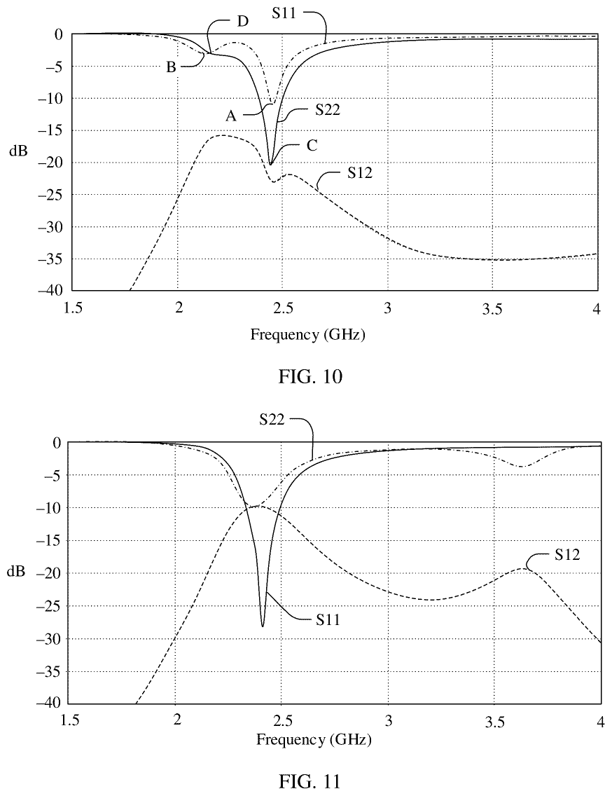

FIG. 10 is an S parameter curve diagram of the first antenna and the second antenna according to an embodiment of this application. As shown in FIG. 10, in a specific embodiment of this application, when an operating frequency band of the antenna system 2 includes at least a part of 2.4 GHz to 2.5 GHz, a first resonance and a fourth resonance are used to cover an operating frequency band. The S parameter curve diagram has an obvious isolation pit, and isolation is less than −20 dB. The electrical component 34 is disposed on the second sub stub 322, to adjust an equivalent electrical length of the second sub stub 322, so that a resonance (for example, including a frequency of 2.1 GHz) generated by the second sub stub and the electrical component 34 is lower than an operating frequency (for example, including a frequency of 2.4 GHz) of an antenna system including the first antenna 3 and the second antenna 4. Therefore, isolation and efficiency of the first antenna 3 are improved.

FIG. 11 is an S parameter curve diagram of the first antenna and a second antenna when the second sub stub is directly coupled to the ground. As shown in FIG. 11, when the second sub stub 322 is not connected to the electrical component 34, isolation between the first antenna 3 and the second antenna 4 is only −10 dB.

Specifically, when the fourth stub 42 is disposed, the fourth stub 42 includes a third open end 421, and the third open end 421 is located at a second end of the fourth stub 42. The foregoing slot exists between the third open end 421 and the second sub stub 322.

A width of the slot may be specifically 0.5 mm to 2 mm. For example, the width of the slot may be 0.8 mm, 1 mm, 1.2 mm, 1.5 mm, 1.7 mm, 1.8 mm, or the like. In this solution, the first antenna 3 and the second antenna 4 are disposed compactly, which helps reduce space occupied by the antennas.

In an embodiment, a difference between a physical length of the fourth stub 42 and a physical length of the first sub stub 321 is within 30%. In a specific embodiment, the closer the physical length of the fourth stub 42 to the physical length of the first sub stub 321, the more conducive to improving the antenna efficiency of the first antenna 3, and the more conducive to improving the isolation between the first antenna 3 and the second antenna 4 in the antenna system.

In an embodiment, the fourth stub 42 may be formed on the side frame of the housing of the electronic device, where open ends of the fourth stub 42 may correspond to an insulated gap on the side frame.

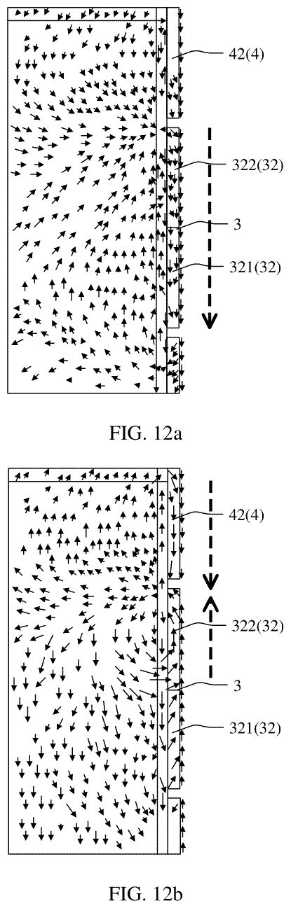

FIG. 12a is a diagram of current distribution of the first antenna according to an embodiment of this application, and FIG. 12b is a diagram of current distribution of the second antenna according to an embodiment of this application. As shown in FIG. 12a, when the first antenna 3 receives feeding, the first sub stub 321 and the second sub stub 322 are used as an integral structure as a wire antenna, and a current flows around the entire first stub 31 and the second stub 32 to form a first resonance. As shown in FIG. 12b, the second sub stub 322 and the fourth stub 42 share the foregoing slot, and a current flows around the second sub stub 322 and the fourth stub 42 respectively to form an open slot antenna, to generate a third resonance. A center frequency of the first resonance point (a center frequency of the first antenna 3) is the same as or adjacent to a center frequency of the third resonance (a center frequency of the second antenna 4). In addition, the second sub stub 322 generates a second resonance and a fourth resonance after the electrical component 34 is loaded, and center frequencies of the second resonance and the fourth resonance are less than the center frequency of the first resonance and the center frequency of the third resonance. In this embodiment of this application, an operating mode of the antenna is adjusted by disposing the electrical component 34, to form good isolation between the first antenna 3 and the second antenna 4.

Specifically, an operating frequency band of the wire antenna includes the first frequency band, an operating frequency band of the open slot antenna includes a second frequency band, and the first frequency band and the second frequency band at least partially overlap. In this case, the antenna system in this embodiment of this application can improve isolation and reduce interference between antennas. A frequency difference between a center frequency of the first frequency band and a center frequency of the second frequency band is less than or equal to 15% of a lower center frequency.

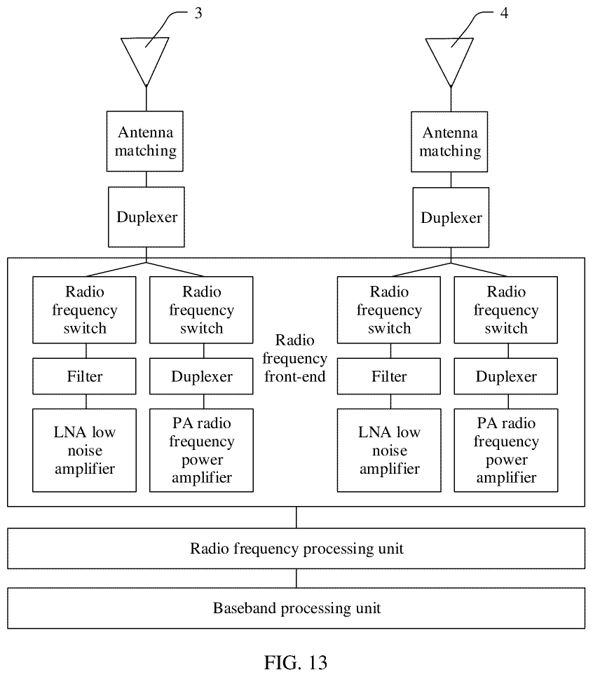

FIG. 13 is an operating architectural diagram of the first antenna and the second antenna according to an embodiment of this application. As shown in FIG. 13, the first antenna 3 and the second antenna 4 in this embodiment of this application cooperatively operate. In a communication system, the first antenna 3 and the second antenna 4 enter a radio frequency processing unit and a baseband processing unit through a radio frequency front-end, to form a dual-antenna operating mode. During a specific application, the first antenna 3 and the second antenna 4 may be communication systems of a same standard, or may be communication systems of different standards. For example, the first antenna 3 is a cellular system antenna, and the second antenna 4 is a Wi-Fi antenna. In different operating standards, the antennas are connected to respective radio frequency front-ends and systems. This does not affect an operating principle of the antenna in the present invention.

When the first antenna 3 and the second antenna 4 are specifically formed, the fourth stub 42 and the second sub stub 322 may be located on a same mechanical part. For example, the mechanical part may be a side frame of a mobile terminal. It should be understood that “being located on a same mechanical part” may be understood as that at least a part of the fourth stub 42 includes a first part of a mechanical part, and at least a part of the second sub stub 322 includes a second part of the mechanical part. In an embodiment, the mechanical part has the foregoing slot (for example, an insulated gap). When the fourth stub 42 and the second sub stub 322 are specifically formed, a slot may be directly formed on the mechanical part, and the fourth stub 42 and the second sub stub 322 may be formed. In addition, the fourth stub 42 and the second sub stub 322 may be further located on a same plane, which facilitates preparation of the antenna system 2 and helps reduce space occupied by the antenna system 2.

Similarly, in this application, an example in which the main radiator of the second antenna 4 is an L-shaped stub is used in FIG. 7. In other words, the main radiator of the first antenna 3 includes only the third stub 41 and the fourth stub 42. However, in another embodiment, in addition to the third stub 41 and the fourth stub 42, the main radiator of the second antenna 4 may further include another stub, that is, the main radiator may be of a more complex stub structure.

In another specific embodiment, a length of the second sub stub 322 is 20% to 95% of a length of the first sub stub 321. Further, the length of the second sub stub 322 may alternatively be 30% to 95% of the length of the first sub stub 321. For example, the length of the second sub stub 322 is 23%, 25%, 28%, 30%, 35%, 39%, 40%, 41%, 45%, 47%, 50%, 52%, 55%, 57%, 60%, 63%, 65%, 67%, 70%, 72%, 75%, 77%, 80%, 81%, 82%, 85%, or 88% of the length of the first sub stub 321, which is not enumerated herein one by one.

An equivalent capacitance value of the foregoing capacitive component is between 0.2 pf and 6 pf, and a capacitance value within this range can meet a requirement of improving antenna efficiency and improving isolation. Specifically, when the electrical component 34 is a fixed-value capacitor, an electrical component 34 having an appropriate equivalent capacitance value may be selected based on an actual operating status. For example, an equivalent capacitance value of the foregoing fixed-value capacitor may be 0.4 pf, 0.5 pf, 0.8 pf, 1 pf, 1.2 pf, 1.5 pf, 1.8 pf, 2 pf, 2.4 pf, 2.5 pf, 3 pf, 3.5 pf, 3.6 pf, 4 pf, 4.2 pf, 4.5 pf, 5 pf, 5.5 pf, or the like.

In another embodiment, there may be one or more capacitive components. In this case, a capacitance value of each of the foregoing capacitive components is within a range of 0.2 pf to 6 pf.

The foregoing capacitive component may alternatively be an adjustable capacitor. In this case, an adjustable capacitance value range of the adjustable capacitor at least partially overlaps the foregoing range of 0.2 pf to 6 pf. In a specific embodiment, the adjustable capacitor may mean switching capacitors with fixed capacitance values through a switch, or may mean forming series and/or parallel capacitors by turning on one or more switch branches. Certainly, the adjustable capacitor may alternatively be an adjustable capacitor with a steplessly-adjustable capacitance value.

When the foregoing electrical component 34 is specifically disposed, the electrical component 34 is coupled to the second sub stub 322 at a second connection point. A distance between the second connection point and the slot is less than a distance between the second connection point and the first connection point 33. That is, the electrical component 34 is coupled to an end part of a side that is of the second sub stub 322 and that is closer to the slot. Specifically, the distance between the second connection point and the slot may be a distance between the second connection point and an end face of the side that is of the second sub stub 322 and that is closer to the slot. In this solution, a length of the second sub stub 322 may be fully used, that is, a structure of the second sub stub 322 is fully used to radiate a signal.

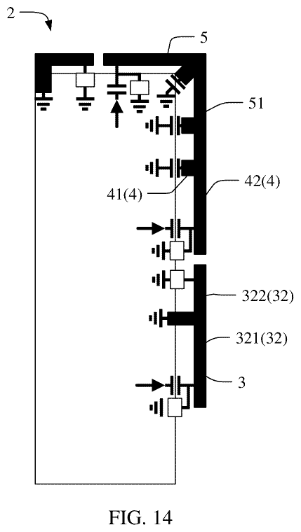

FIG. 14 is another diagram of a structure of the antenna system according to an embodiment of this application. As shown in FIG. 14, the antenna system 2 includes a third antenna 5, and the third antenna 5, the second antenna 4, and the first antenna 3 are sequentially disposed. Specifically, the third antenna 5 includes a fifth stub 51, and the fifth stub 5 is disposed on a side that is of the fourth stub 42 and that is away from the second sub stub 322. In an embodiment, the fifth stub 51 is connected to the fourth stub 42. Alternatively, an end that is of the fifth stub 51 and that faces the fourth stub 42 is an open end, the fifth stub 51 and the fourth stub 42 are disposed opposite to each other, and a slot exists between the open end of the fifth stub 51 and the fourth stub 42.

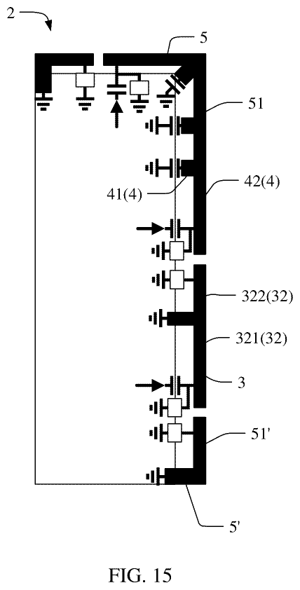

FIG. 15 is another diagram of a structure of the antenna system according to an embodiment of this application. As shown in FIG. 15, in another embodiment, when the antenna system 2 includes a third antenna 5′, the second antenna 4, the first antenna 3, and the third antenna 5′ are sequentially disposed. A fifth stub 51′ is disposed on a side that is of the first sub stub 321 and that is away from the fourth stub 42. Similarly, an end that is of the fifth stub 51′ and that faces the first sub stub 321 is an open end, the fifth stub 51′ is disposed opposite to the first sub stub 321, and a slot exists between the open end of the fifth stub 51′ and the first sub stub 321. Alternatively, in another embodiment, the fifth stub 51′ is connected to the first sub stub 321. This is not limited in this application.

In conclusion, in this solution, a quantity of antennas included in the antenna system 2 is not limited in this application.

As shown in FIG. 14 and FIG. 15, in embodiments of this application, a part that is of the antenna and that is coupled to the second feed circuit may enable the antenna to be directly coupled to the second feed circuit, or may enable an electrical component to be coupled between the antenna and the second feed circuit. The electrical component may be specifically an adjustable component. For example, an adjustable component is coupled between the second stub 32 and the second feed circuit, so that an operating frequency band of the first antenna 3 can be switched. Similarly, an adjustable component may also be coupled between the fourth stub 42 and the second feed circuit, so that an operating frequency band of the second antenna 4 can be switched. In addition, a ground stub of the antenna may also be coupled through an electrical component. In other words, the first stub 31 may be coupled to the ground through an electrical component, and the third stub 41 may also be coupled to the ground through an electrical component. This is not limited in this application.

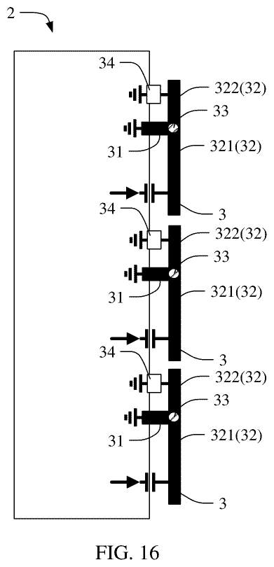

FIG. 16 is another diagram of a structure of the antenna system according to an embodiment of this application. As shown in FIG. 15, in another embodiment, the second antenna and the third antenna are similar to the first antenna. Alternatively, it may be understood that a plurality of first antennas 3 are disposed in sequence, a slot exists between two adjacent first antennas 3, and isolation between adjacent antennas is improved by disposing an electrical component, to form an antenna array with high isolation.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1-22. (canceled)

23. An antenna system, comprising a first antenna and a ground, wherein the first antenna comprises:
a first feed circuit and an electrical component; and
a first stub and a second stub, wherein the second stub is coupled to the first stub at a first connection point, the second stub comprises a first sub stub and a second sub stub, and the first sub stub and the second sub stub are located on two different sides of the first connection point; and
the first stub is coupled to the ground, the first sub stub is coupled to the first feed circuit, the second sub stub is coupled to the ground through the electrical component, and a length of the second sub stub is different from a length of the first sub stub,
wherein the first antenna generates a first resonance and a second resonance, a center frequency of the first resonance is higher than a center frequency of the second resonance, and the first resonance covers an operating frequency band of the first antenna,
the first sub stub, the second sub stub, and the electrical component are configured to generate the first resonance, and at least one current corresponding to the first resonance is codirectional on the first sub stub and the second sub stub, and
wherein the first sub stub and the second sub stub extend on a same straight line.

24. The antenna system according to claim 23, wherein the length of the second sub stub is less than the length of the first sub stub, the electrical component is a capacitor, and an equivalent capacitance value of the capacitor is within a range of 0.2 pf to 6 pf.

25. The antenna system according to claim 24, wherein the electrical component comprises one or more capacitors, and a capacitance value of each capacitor is within the range of 0.2 pf to 6 pf.

26. The antenna system according to claim 23, wherein the length of the second sub stub is 30% to 95% of the length of the first sub stub.

27. The antenna system according to claim 23, wherein a frequency difference between the center frequency of the first resonance and the center frequency of the second resonance is less than or equal to 15% of a lower center frequency.

28. The antenna system according to claim 23, wherein the second sub stub and the electrical component are configured to generate the second resonance, and at least one current corresponding to the second resonance is codirectional on the second sub stub.

29. The antenna system according to claim 23, wherein the second stub comprises a first open end and a second open end, the first open end is located at an end that is of the first sub stub and that is disposed with a gap from the second sub stub, and the second open end is located at an end that is of the second sub stub and that is disposed with the gap from the first sub stub.

30. The antenna system according to claim 29, wherein a distance between the second open end and a position at which the electrical component is coupled to the second sub stub is within 40% of a total length of the second sub stub.

31. The antenna system according to claim 23, further comprising a second antenna, wherein the second antenna comprises:
a second feed circuit; and
a third stub and a fourth stub, wherein a first end of the fourth stub is coupled to the third stub, the third stub is coupled to the ground, the fourth stub is coupled to the second feed circuit, a second end of the fourth stub is disposed with a gap to the second sub stub, by a slot

32. The antenna system according to claim 31, wherein the fourth stub comprises a third open end, and the third open end is the second end of the fourth stub.

33. The antenna system according to claim 31, wherein a physical length L4 of the fourth stub and a physical length L11 of the first sub stub satisfy a formula of L4=L11*(100±30)%.

34. The antenna system according to claim 31, wherein the second antenna generates a third resonance and a fourth resonance, a center frequency of the third resonance is higher than a center frequency of the fourth resonance, and the third resonance covers an operating frequency band of the second antenna.

35. The antenna system according to claim 34, wherein a frequency difference between the center frequency of the third resonance and the center frequency of the fourth resonance is less than or equal to 15% of a lower center frequency.

36. The antenna system according to claim 34, wherein the fourth stub, the second sub stub, and the electrical component are configured to generate the third resonance, and at least one current corresponding to the third resonance is reverse on the fourth stub and the second sub stub.

37. The antenna system according to claim 36, wherein the second sub stub and the electrical component are configured to generate the fourth resonance, and at least one current corresponding to the fourth resonance is codirectional on the second sub stub.

38. The antenna system according to claim 31, wherein:
the operating frequency band of the first antenna comprises a first frequency band; and
the operating frequency band of the second antenna comprises a second frequency band; and
a frequency difference between a center frequency of the first frequency band and a center frequency of the second frequency band is less than or equal to 15% of a lower center frequency.

39. An electronic device, comprising a housing and an antenna system, wherein the antenna system comprises a first antenna and a ground, wherein the first antenna comprises:
a first feed circuit and an electrical component; and
a first stub and a second stub, wherein the second stub is coupled to the first stub at a first connection point, the second stub comprises a first sub stub and a second sub stub, and the first sub stub and the second sub stub are located on two different sides of the first connection point; and
the first stub is coupled to the ground, the first sub stub is coupled to the first feed circuit, the second sub stub is coupled to the ground through the electrical component, and a length of the second sub stub is different from a length of the first sub stub,
wherein the first antenna generates a first resonance and a second resonance, a center frequency of the first resonance is higher than a center frequency of the second resonance, and the first resonance covers an operating frequency band of the first antenna,
the first sub stub, the second sub stub, and the electrical component are configured to generate the first resonance, and at least one current corresponding to the first resonance is codirectional on the first sub stub and the second sub stub, and
wherein the first sub stub and the second sub stub extend on a same straight line,
wherein a partial structure of the housing forms the second stub; or the antenna system is disposed in the housing.

40. The antenna system according to claim 39, wherein the length of the second sub stub is less than the length of the first sub stub, the electrical component is a capacitor, and an equivalent capacitance value of the capacitor is within a range of 0.2 pf to 6 pf.

41. The antenna system according to claim 39, wherein the length of the second sub stub is 30% to 95% of the length of the first sub stub.

42. The antenna system according to claim 39, wherein the second stub comprises a first open end and a second open end, the first open end is located at an end that is of the first sub stub and that is disposed with a gap to the second sub stub, and the second open end is located at an end that is of the second sub stub and that is disposed with the gap to the first sub stub, a distance between the second open end and a position at which the electrical component is coupled to the second sub stub is within 40% of a total length of the second sub stub.
